(19) United States
(12) Patent Application Publication
(10) Pub. No.: US 2015/0113567 A1
(43) Pub. Date: Apr. 23, 2015

(54) METHOD AND APPARATUS FOR A CONTEXT AWARE REMOTE CONTROLLER APPLICATION

(71) Applicant: Verizon Patent and Licensing Inc., Basking Ridge, NJ (US)

(72) Inventor: Fred SCHEER, Bradford, MA (US)

(73) Assignee: Verizon Patent and Licensing Inc., Basking Ridge, NJ (US)

(21) Appl. No.: 14/061,465

(22) Filed: Oct. 23, 2013

(51) Int. Cl. H04N 21/422; H04N 21/482

(52) U.S. Cl. CPC H04N 21/42227; H04N 21/42209; H04N 21/4222; H04N 21/482
USPC 725/46; 725/44

(57) ABSTRACT

An approach for implementing a context-aware remote controller application on a controller device for interfacing with one or more target devices and controlling one or more functionalities and/or processes at the target includes determining a current state associated with one or more applications, one or more content items or a combination thereof at a user device. The approach also includes communicating a change in the current state to a controller device via a context update message, wherein the context update message encodes the current state, the change in the current state, or a combination thereof as a context identifier. Further, the approach includes initiating a presentation of one or more user interface options at the controller device based on the context update message, the context identifier, or a combination thereof.

### BACKGROUND INFORMATION

With technological advances in available user devices and applications, many users utilize a variety of devices to perform various tasks throughout the day. For example, a user device (e.g., a mobile phone, tablet, laptop computer, personal projectors, a television set (TV), a set-top box, etc.) and relevant applications may be utilized to access or provide services for entertainment, business transactions, education, data processing, or the like. Additionally, since many of the user devices have capabilities to communicate with other user devices, some users may utilize one user device and applications thereon to interface with and control another device and various processes or applications on that other device. For example, a user may use a tablet to interface with a game console and control various functionalities or applications running on the game console. In another example, a user may utilize a mobile phone to interface with a set-top box and control a media consumption (e.g., playback, view, listen, read, etc.) session streaming via that set-top box. However, as the user devices may have different functionalities and applications, a user interface (UI) at one device may be different than a UI on another device. Additionally, a UI and available options at a controller device may not be optimal for interfacing and controlling another user device since the UI and any options presented at the controller device may be due to default settings associated with the controller device and/or the user device that is to be interfaced with and controlled.

Based on the foregoing, there is a need for a context aware remote controller application.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of implementing a context aware remote controller application, according to one embodiment;

FIG. 2 is a diagram of the components of a context aware controller application, according to one embodiment;

FIG. 3 is a diagram of the components of a remote control application, according to one embodiment;

FIG. 4 is a flowchart of a process for determining status information that a user device, according to one embodiment;

FIG. 5 is a flowchart of a process for generating and communicating status contextual information, according to one embodiment;

FIG. 6 is a flowchart of a process for validating and utilizing context identifiers, according to one embodiment;

FIG. 7 is a diagram of a communication flow between a target device and a controller device, according to one embodiment;

FIGS. 8A through 8D are diagrams of user interfaces for use in the processes of FIGS. 4 through 7, according to various embodiments;

FIG. 9 is a diagram of a computer system that can be used to implement various exemplary embodiments; and

FIG. 10 is a diagram of a chip set that can be used to implement an embodiment of the invention.

### DESCRIPTION OF THE PREFERRED EMBODIMENT

An apparatus, method and software for facilitating a context aware remote controller application are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

Although the various exemplary embodiments are described with respect to interfacing with a user device (e.g., a TV set, a set-top box, etc.) and controlling a media consumption process thereon, it is contemplated that these embodiments have applicability to a variety of user devices and processes where a user may wish to utilize one user device (a controller device) to remotely interface with and control another user device (a target device) and any processes, applications, content items, etc. thereon.

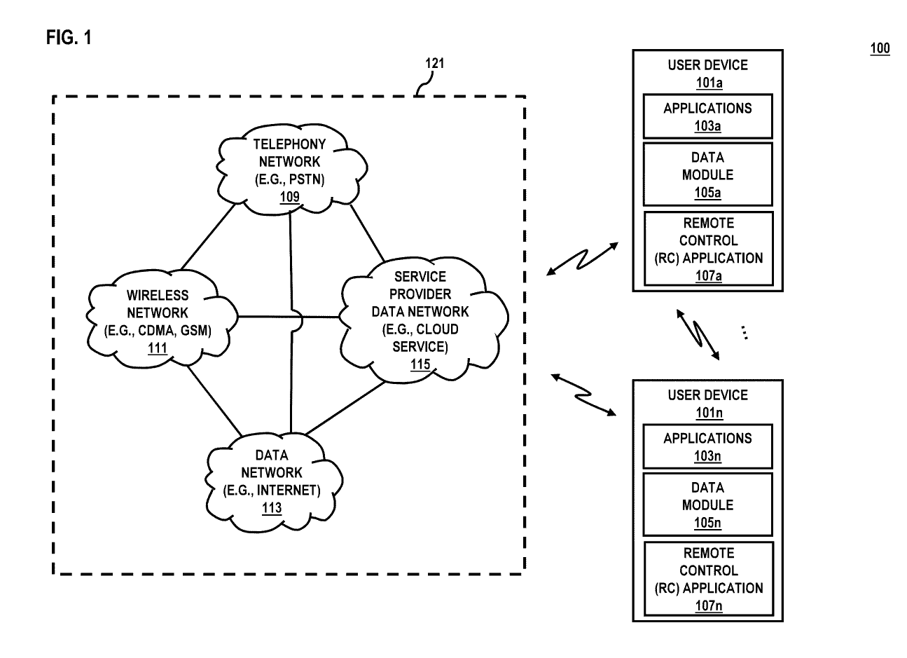

FIG. 1 is a diagram of a system for implementing a context-aware remote controller application on one or more controller devices for interfacing with one or more target devices and controlling one or more functionalities and/or processes at the target devices. As previously discussed, with proliferation of electronic user devices available to users, the users may utilize a controller device to interface with a target device and control various functionalities, processes, or applications which may be available at the target device. For example, a user may use a mobile phone to interface with a TV set and control various functionalities of the TV. In another example, a user may interface with a video/audio component for controlling a consumption of a media content item, which may be streamed or replayed via that component. However, a regular controller device or application may not have contextual information associated with processes, applications, media content, games, or the like that may be available or active at a target device, which the user may wish to control. As a consequence, the available UI or options at a controller device may not be optimal for interfacing with and controlling the target device. For example, the UI at a controller device may present the same static control options regardless of what processes or applications may be active at the target device, and the options may not be intuitive or optimal for a better user experience. In some instances, a graphical UI including a variety of options, buttons, information items, etc. presented on a controller device may have no contextual relevance to what a user is currently doing/interfacing with a target device, e.g., viewing a streaming media item on a TV set via a set-top box. For example, if no media is currently playing on the TV set, then it may be unnecessary for a controller device/application to display media control options as they would have no functional purpose. In another scenario, too many graphical buttons or other interface options simultaneously presented at a controller device could create a UI that may be cluttered, confusing or difficult to see, especially when a controller device may have a smaller display size (e.g., on a smartphone.) Additionally, some controller devices may utilize a touch sensitive UI and if the control options/buttons are presented/placed too close to each other, then it may be difficult for a user to accurately interact with the options/buttons such that the user may cause an accidental button-press or other control commands to be sent to a target device and cause an unintended operation and user frustration. Therefore, there is a need for a context-aware remote controller application for providing a dynamic, context sensitive, and customizable UI and relevant control options at a controller device.

To address these issues, system 100 of FIG. 1 provides the capability for implementing a context-aware remote controller application, according to one embodiment. As previously discussed, a controller device and a target device may utilize a context-aware controller application to communicate with each and share information related to user activities and/or processes at the controller or target device. In various embodiments, a context-aware controller application may determine and share information on a current state at a target device with a controller device where the controller device and/or the target device may initiate a presentation of a dynamic UI and relevant context-aware/sensitive control options at the controller device. Additionally, as user control commands may affect state changes at the target device, the controller applications at the target or controller device may dynamically communicate the changes via one or more context/status update messages so that the two devices remain synchronized with each other. In one scenario, a simplified UI with fewer controls/options may be presented at the controller device while omitting unnecessary control options for the given scenario. For example, presentation of fewer graphical controls/options may provide for larger icons in a larger touch area, which could reduce the potential for inadvertent user interaction with the controls/options.

In one embodiment, a controller device may utilize a bi-directional communication channel (e.g., wireless or wired) to communicate to a target device control commands that may affect state changes at the target device. Similarly, the target device may communicate one or more state change update messages to the controller device, which may cause an update to the UI at the controller device.

In one embodiment, a target device may initiate an asynchronous context update message to communicate to the controller device one or more state changes at the target device. In one embodiment, the controller device may use information contained in the context update message to determine and present a UI including relevant options and context sensitive information. For example, if the state at the target device changes to present a list of movie assets, then the context update message communicated to the controller device may contain a context identifier for the new state, the number of movies in the list, the position of a selected movie within the list, movie asset information such as title or asset identification, or the like. In one embodiment, a context identifier may represent the state of an application at a target device wherein a controller device may determine and present a UI based on that context identifier. In one embodiment, a controller device may include a context identifier in a control command message communicated to a target device so to identify the state of an application or a process targeted at the target device.

In one embodiment, a target device may communicate a timer based context update message to a controller device (e.g., at predetermined intervals) to indicate a progress related to an ongoing activity. For example, the remaining/watched percentage of a currently playing movie.

For the purpose of illustration, the system 100 may include one or more user devices 101a-101n (user device 101), which may include, execute, and utilize one or more applications 103a-103n (also referred to as applications 103), one or more data modules 105a-105n (also referred to as Data module 105), and remote control applications 107a-107n (also referred to as RC application 107.) In one embodiment, the RC applications 107 may be installed on a plurality of user devices 101 so that those devices may interface with one another for effectuating various processes for determining and communicating one or more status control messages associated with a given user device 101. In one scenario, in a group of user devices 101, one or more devices may perform additional functions for controlling or managing other devices or applications/processes on those other devices. A user may use or dedicate any user device 101 as a controller device, e.g., a tablet as a controller device, for controlling applications/process at other user devices 101 (target devices), e.g., a personal computer, a projector, a TV set, a set-top box, a game console, a media player/recorder, or the like. Depending on capabilities of the user devices 101 of a user, a controller device and a target device may have similar, same, or different functionalities and/or may utilize or execute various functionalities of an RC application 107. In various embodiments, an RC application 107 may be an independent application or widget which may be included in a user device by a manufacturer of the user device, or it may be downloaded by a user of the user device. Additionally, the RC application 107 may be independent of an operating system of a user device or it may be implemented based on the operating system at the user device.

Furthermore, the system 100 may include a network system 121, which may include one or more networks, including a telephony network 109, a wireless network 111, a data network 113, a service provider data network 115, etc. By way of example, the networks 109, 111, 113, and 115 may be any suitable wireline and/or wireless network, which may be managed by one or more service providers. In one example, the networks 109, 111, 113, and 115 may be one or more elements in a network system 121, which may include various components and elements for providing a range of communication and network services. For example, telephony network 109 may include a circuit-switched network, such as the public switched telephone network (PSTN), an integrated services digital network (ISDN), a private branch exchange (PBX), or other like network. Wireless network 111 may employ various technologies including, for example, code division multiple access (CDMA), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like. Meanwhile, data network 113 may be any local area network (LAN), metropolitan area network (MAN), wide area network (WAN), the Internet, or any other suitable packet-switched network, such as a commercially owned, proprietary packet-switched network, such as a proprietary cable or fiber-optic network.

Although depicted as separate entities, networks 109, 111, 113, and 115 may be completely or partially contained within one another, or may embody one or more of the aforementioned infrastructures. For instance, the service provider network 115 may embody circuit-switched and/or packet-switched networks that include facilities to provide for transport of circuit-switched and/or packet-based communications. It is further contemplated that networks 109, 111, 113, and 115 may include components and facilities to provide for signaling and/or bearer communications between the various components or facilities of system 100. In this manner, networks 109, 111, 113, and 115 may embody or include portions of a signaling system 7 (SS7) network, or other suitable infrastructure to support control and signaling functions.

By way of examples, the user devices 101 may communicate with other devices via one or more proximity-based communication channels or via one or more network service providers in the network system 121. Further, the applications 103 may include various applications for productivity, education, entertainment, social networking, web browser, communications, content sharing, multimedia applications, user interface (UI), map application, web client, or the like.

In one embodiment, a user device 101 may utilize a Data module 105 for determining/collecting data or content associated with the user device 101, one or more users of the user device 101, the applications 103, one or more content items (e.g., multimedia content), and the like. In addition, the user device 101 can execute an application 103 that is a software client for storing, processing, and/or forwarding one or more information items to other components of the system 100. In various embodiments, the Data module 105 may include various sensors for detecting and capturing various signals, information, and contents, for example, audio, video, location information, Bluetooth signals, near field communication (NFC) signals, wireless local area network (WLAN) signals, RFID signals, or the like. Further, the collected information, content, or signals may be shared, via the applications 103 and/or the RC application 107, with other user devices 101, or service providers in the network system 121.

It is noted that user devices 101 may be any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), smartphone, set-top box, TV set, or any combination thereof. It is also contemplated that the user devices 101 can support any type of interface for supporting the presentment or exchanging of data. In addition, user devices 101 may facilitate various input means for receiving and generating information, including touch screen capability, keyboard and keypad data entry, voice-based input mechanisms and the like. Any known and future implementations of user devices 101 are applicable. In certain embodiments, user devices 101 may be configured to establish peer-to-peer communication sessions with each other using a variety of technologies, including near field communication (NFC), Bluetooth, ZigBee, infrared, etc. Also, connectivity can be provided via a wireless local area network (LAN). By way of example, a group of user devices 101 may be configured to a common LAN so that each device can be uniquely identified via any suitable network addressing scheme.

In one embodiment, an RC application 107 may be utilized to determine various information items associated with a one or more processes or applications at a user device 101 and communicate that information to one or more other of devices 101 for effectuating a remote control of one user device 101 by another user device 101. In one use case scenario, a target device 101 (e.g., a media player) may determine one or more information items relevant to status of one or more processes, applications (e.g., applications 103), content items, or the like on that target device and communicate the information items via a context update message to a controller device 101. Further, an RC application 107 at a controller device 101 may receive and process the context update message to determine the status information for the target device 101, wherein a UI with relevant information and control options may be presented at the controller device 101. In one embodiment, the UI and the relevant information for presentation at the controller device 101 and/or at the target device 101 may be determined by the target device 101. In one embodiment, the controller device 101 may determine the UI and the relevant information.

In various embodiments, the user devices 101 may communicate with each other via one or more proximity-based communication methods and protocols. For example, the communication may be via Bluetooth®, a wireless local area network (WLAN), or other available communication methods. In various examples, the RC application 107 may communicate with one or more networks and service providers of the network system 121 to provide information and/or request information or services from the service providers. In various scenarios, a RC application 107 on a user device 101 may request or utilize information from the applications 103 or the Data module 105 to determine status information associated with one or more processes, applications, content items, UI presentation options, available control options, available functionalities, user profile, user preferences, user configuration, device configuration, or the like.

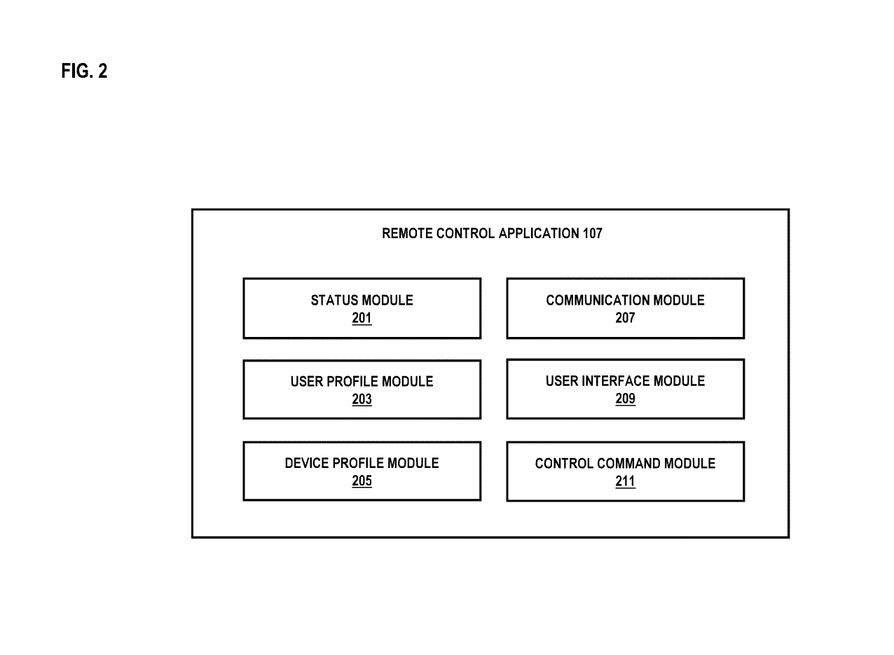

FIG. 2 is a diagram of the components of a remote control application, according to one embodiment. By way of example, an RC application may include one or more components for facilitating device remote control procedures. The components may be implemented in hardware, firmware, software, or a combination thereof. It is contemplated that the functions of these components may be combined in one or more components or performed by other components of equivalent functionality. In one embodiment, the RC application 107 may include a status module 201, a user profile module 203, a device profile module 205, a communication module 207, user interface module 209, and control command module 211. The RC application 107 may be executed via one or more processors at a user device 101 and perform various tasks as a standalone application or in conjunction with various modules and applications at the user device 101.

In one embodiment, the status module 201 at a target device 101 (e.g., a media streamer) may determine one or more information items relevant to status of one or more processes, applications (e.g., applications 103), content items, or the like on that target device 101 and communicate the information items in a context update message via the communication module 207 to a controller device 101. Further, a status module 201 at a controller device 101 may receive and process the context update message to determine the status information at the target device 101. In one embodiment, the status module 201 may determine or generate a context identifier for a current status or for a change in the current status at a target device 101 and include the context identifier in the context update message. In one embodiment, a status module 201 at a controller device 101 may receive and process the context identifier for determining a current status or a change in the current status associated with a target device 101. In various scenarios, the status module may determine information associated with the status of a process, an application, a content item, device status, or the like.

In one embodiment, the user profile module 203 may include information associated with one or more users who may utilize a target and/or a controller device 101. In one example, the user profile information may be determined from a user profile associated with a particular user device 101 or it may be obtained from a service provider or a storage device based on user information determined from the user (e.g., user name, user login, user credentials, etc.) In one scenario, a user profile may indicate user privileges to access or use various applications or resources available at or via the user device 101, which may be available via local or network services.

In one embodiment, the device profile module 205 may include device information indicative of available resources, applications, services, or the like, which may be available at the device or via the device. For example, a user may utilize various applications available at a user device 101 or the user may utilize the user device 101 to access various applications, services, resources, or the like that may be available via a local or cloud-based network service. In one embodiment, a user device profile may be associated with one or more user profiles who may share that user device, wherein a user profile may indicate as to how, where, or when a user may access or utilize the user device.

In one embodiment, the communication module 207 may be utilized to communicate with various applications, modules, or components of a user device 101 for sharing various status information associated with the user device 101. In one embodiment, the RC application 107 may utilize the communication module 207 to directly communicate with one or more other user devices 101, device management systems/services, or the like. In one scenario, the communication may be effectuated via a communication module available at the user device 101. In one embodiment, the communication module 207 may utilize one or more communication channels to communicate one or more context update message, command message, inquiry message, or the like.

In one embodiment, the UI module 209 may cause a rendering or presentation of a dynamic UI including various information and options associated with our processes, applications, content items, or the like. In one example, the presentation may include visual effects on the presented options. In various scenarios, the presentation may include one or more augmented or virtual reality elements, which may provide additional visual effects for a better, more effective, or user friendly experience. In one embodiment, the UI module 209 may cause a presentation of a UI at a user device so that a user may interact with one or more elements present in a media item, one or more current status update information, or the like. In one embodiment, the UI may provide various options for a user to select, highlight, or float over one or more content items at a target device 101. In one embodiment, the UI elements may be determined at a controller device 101 may be based on contextual information determined from a context update message received from a target device 101. In one embodiment, the UI elements may be determined by a target device 101 and communicated to and for presentation at a controller device 101.

In one embodiment, the control command module 211 at a controller device 101 may generate one or more control commands for effectuating a status change at a target device 101. In one embodiment, the control command module 211 at a target device 101 may receive and process a control command to determine a status change targeting a process, application, content item, or the like that a user may wish to interface with and effectuate the status change.

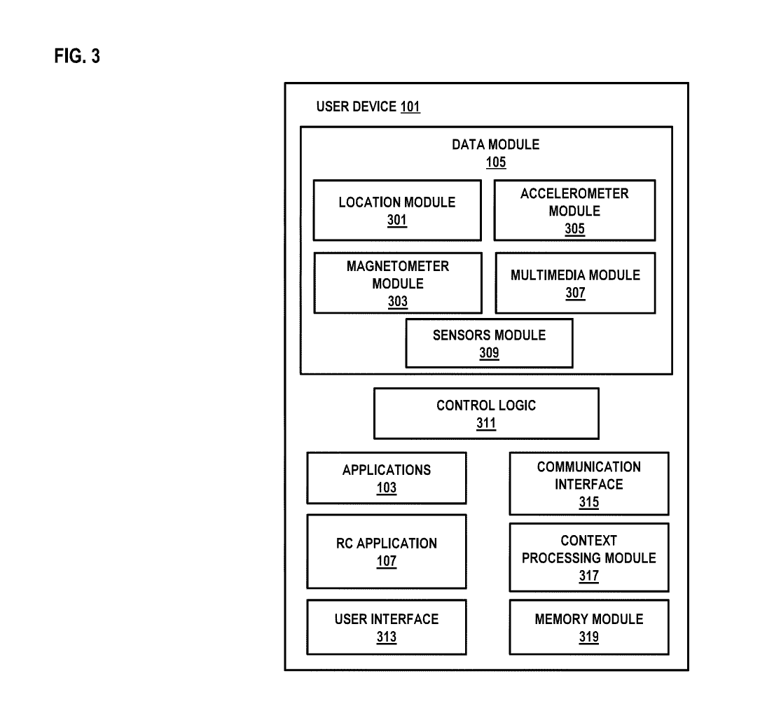

FIG. 3 is a diagram of the components of a user device, according to one embodiment. By way of example, a user device 101 includes one or more components for executing various applications, enabling various functionalities, and for communicating with other user devices 101 or with other components of the system 100. It is contemplated that the functions of these components may be combined in one or more components or performed by other components of equivalent functionality. In one embodiment, the user device 101 includes a Data module 105, which may include one or more location modules 301, magnetometer modules 303, accelerometer modules 305, multimedia module 307, and sensors module 309. Further, the user device 101 may also include control logic 311 to coordinate the use of other components of the user device 101, a user interface 313, a communication interface 315, a context processing module 317, and a memory module 319. The applications 103 and the RC application 107 may execute on the control logic 311 utilizing the components of the user device 101.

The location module 301 can determine a user's location, for example, via location of a user device 101. The user's location can be determined by a triangulation system such as GPS, assisted GPS (A-GPS), Cell of Origin, or other location extrapolation technologies. Standard GPS and A-GPS systems can use satellites to pinpoint the location of a user device 101. A Cell of Origin system can be used to determine the cellular tower that a cellular user device 101 is synchronized with. This information provides a coarse location of the user device 101 because the cellular tower can have a unique cellular identifier (cell-ID) that can be geographically mapped. The location module 301 may also utilize multiple technologies to detect the location of the user device 101. Location coordinates (e.g., GPS coordinates) can give finer detail as to the location of the user device 101 when media is captured. In one embodiment, GPS coordinates are stored as context information in the memory module 319 and are available to the context processing module 317, the Data module 105, and/or to other entities of the system 100 (e.g., via the communication interface 315.) Moreover, in certain embodiments, the GPS coordinates can include an altitude to provide a height. In other embodiments, the altitude can be determined using another type of altimeter. In certain embodiments, the location module 301 can be a means for determining a location of the user device 101, an image, or used to associate an object in view with a location.

The magnetometer module 303 can be used in finding horizontal orientation of the user device 101. A magnetometer is an instrument that can measure the strength and/or direction of a magnetic field. Using the same approach as a compass, the magnetometer is capable of determining the direction of a user device 101 using the magnetic field of the Earth. The front of a media capture device (e.g., a camera) can be marked as a reference point in determining direction. Thus, if the magnetic field points north compared to the reference point, then the angle of the user device 101 from the magnetic field is known. Simple calculations can be made to determine the direction of the user device 101. In one embodiment, horizontal directional data obtained from a magnetometer can be stored in memory module 319, made available to other modules and/or applications 103 of the user device 101, and/or transmitted via the communication interface 315 to one or more entities of the system 100.

The accelerometer module 305 can be used to determine vertical orientation of the user device 101. An accelerometer is an instrument that can measure acceleration. Using a three-axis accelerometer, with axes X, Y, and Z, provides the acceleration in three directions with known angles. Once again, the front of a media capture device can be marked as a reference point in determining direction. Because the acceleration due to gravity is known, when a user device 101 is stationary, the accelerometer module 305 can determine the angle the user device 101 is pointed as compared to Earth's gravity. In certain embodiments, the magnetometer module 303 and accelerometer module 305 can be means for ascertaining a perspective of a user. This perspective information may be stored in the memory module 319, made available to other modules and/or applications 103 of the user device 101, and/or sent to one or more entities of the system 100.

In one embodiment, the multimedia module 307 may be utilized to generate, receive, or consume, etc. various content/media items, for example, images, video, audio, text, and the like. In various embodiments, the media items may be shared with the applications 103 or the RC application 107, which in turn may share the media with one or more components of the system 100. In various embodiments, the multimedia module 307 may interface with various sensors; for example, a camera, a microphone, etc., to determine additional contextual information associated with a media item.

In various embodiments, the sensors module 309 can process sensor data from various sensors (e.g., microphone, optical, Bluetooth, NFC, GPS, accelerometer, gyroscope, thermometer, etc.) to determine environmental (e.g., atmospheric) conditions surrounding the user device 101, user mood, location information, and various other information from a range sensors that may be available on one or more devices. For example, the sensors module 309 may detect conditions including humidity, temperature, geo-location, biometric data of the user, etc. Once again, this information can be stored in the memory module 319 and sent to the context processing module 317 and/or to other entities of the system 100. In certain embodiments, information collected from the Data module 105 can be retrieved by the control logic 311 and stored at the memory module 319, made available to other modules and/or applications 103 of the user device 101, and/or sent to one or more entities of the system 100.

The user interface 313 can include various methods for a user to interface with applications, modules, sensors, and the like at a user device 101. For example, the user interface 313 can have outputs including a visual component (e.g., a screen), an audio component, a physical component (e.g., vibrations), and other methods of communication. User inputs can include a touch-screen interface, a scroll-and-click interface, a button interface, a microphone, etc. An input may be via one or more methods such as voice input, textual input, typed input, typed touch-screen input, other touch-enabled input, etc. In one embodiment, the user interface 313 may interact with the user interface module 209 of the RC application 107 for determining and presenting a dynamic UI and applicable options based on a status at a target device 101 or a controller device 101.

In one embodiment, the communication interface 315 can be used to communicate with one or more entities of the system 100, for example, to submit a request for and receive a content stream from various content stream providers. In various embodiments, the communication interface 315 may facilitate communications via one or more wireless communication channels and protocols, for example, WLAN, RFID, NFC, Bluetooth Smart, Bluetooth, Ant+, Z-Wave, ZigBee, or the like, wherein the communication channels may be established via one or more sensors, transceivers, transmitters, receivers, wireless charging interface, or the like. Certain communications can be via methods such as an internet protocol, messaging (e.g., SMS, multimedia messaging service (MMS), etc.), or any other communication method (e.g., via the network system 121). In some examples, the user device 101 can send context information associated with the user device 101 to other user devices 101 and/or to other entities of the system 100. In one embodiment, the communication interface 315 may interact with the communication module of the RC application 107 in order to effectuate a communication of one or more context update messages, command messages, or the like.

The context processing module 317 may be executing on the control logic 311 for determining context information from the Data module 105, the applications 103, or the RC application 107. This information may be transmitted, via the communication interface 315, to one or more user devices 101 and/or to other entities of the system 100. The context processing module 317 may additionally be utilized as a means for determining information related to the user, an instance of data, a value, a process, a content item, an object, a subject, an application 103 being executed, and the like. In certain embodiments, the context processing module 317 can infer higher level context information from the context data such as activity at a user device 101, user information, etc. In one example, contextual information associated with one or more media items, consumption of a media item, or the like may be determined and shared with one or more user devices 101.

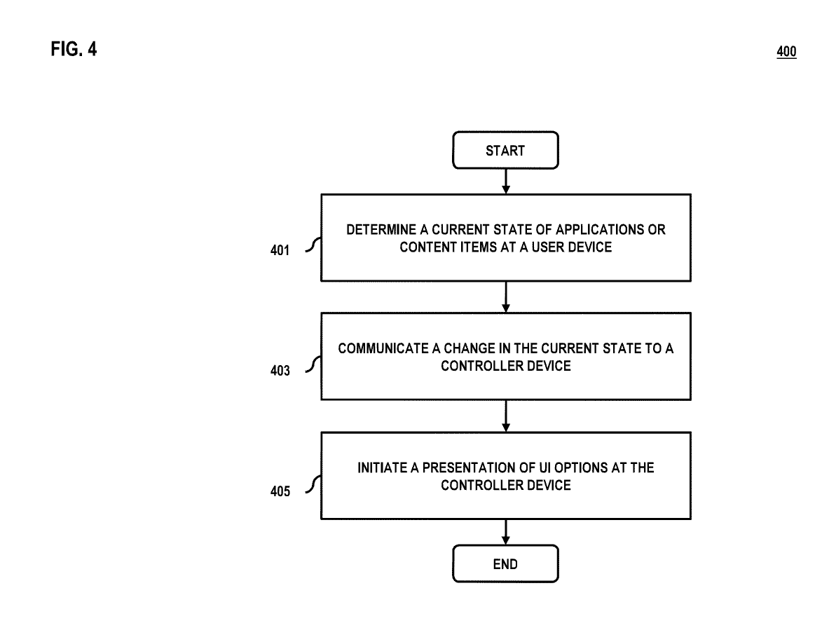

FIG. 4 is a flowchart of a process for determining status information that a user device, according to one embodiment. For the purpose of illustration, process 400 is described with respect to FIG. 1. It is noted that the steps of the process 400 may be performed in any suitable order, as well as combined or separated in any suitable manner.

As shown in FIG. 4, in step 401, an RC application 107 may determine a current state associated with one or more applications, one or more content items or a combination thereof at a user device. In one use case scenario, the RC application 107 at a target device (e.g., a TV set, a set-top box, etc.) may determine the current status information associated with an application that may be used to receive, retrieve, stream, etc. a media content item from one or more sources. For example, a set-top box may be used to download and stream a movie for playback at a TV set. In one instance, the current status may indicate that there are several content items available for user interaction. In one embodiment, the RC application 107 may determine the current state upon powering up the target device.

In step 403, the RC application 107 may communicate a change in the current state to a controller device via a context update message, wherein the context update message encodes the current state, the change in the current state, or a combination thereof as a context identifier (discussed below in steps 501, 503, and 505). In one example, an RC application 107 may monitor and determine a change in the current state associated with the one or more processes, applications, content items, or the like at a target device 101. Further, information about the change in the current state may be communicated to a controller device 101 via a context update message. In one embodiment, the communication between the target device and the controller device is via a direct communication channel, via one or more network devices via the network system 121 or a local network, or a combination thereof.

In step 405, the RC application 107 may initiate a presentation of one or more user interface options at the controller device based the context update message, the context identifier, or a combination thereof. In one embodiment, one or more user interface options include one or more functionalities available at the user device, a list of content items available at the user device, a content consumption progress indicator, or a combination thereof. In one embodiment, an RC application 107 at a target device 101 may determine information for the rendering a presentation of a UI and any relevant options at the controller device 101. For example, the RC application 107 at the target device 101 may analyze and determine an appropriate UI and user options for presentation at a controlled device 101 so that a user may utilize the UI and the user options for interfacing with one or more applications, processes, content items, or the like available at the target device 101. In one embodiment, a controlled device 101 may determine the UI and the user options based on the information determined from the context update message received from the target device 101 and then present the UI and the user options at the controlled device 101. In one embodiment, the presentation of the one or more user interface options at the controller device is further based on one or more activities at the controller device. For example, the RC application 107 (e.g., at a target device 101 or at a controller device 101) may analyze and determine if there are any active applications or processes at a controller device 101 which may need to be considered before a UI is presented. For instance, you might be a particular application with a special which the user may be utilizing at the moment therefore the RC application 107 may need to wait until the user is done with that particular application.

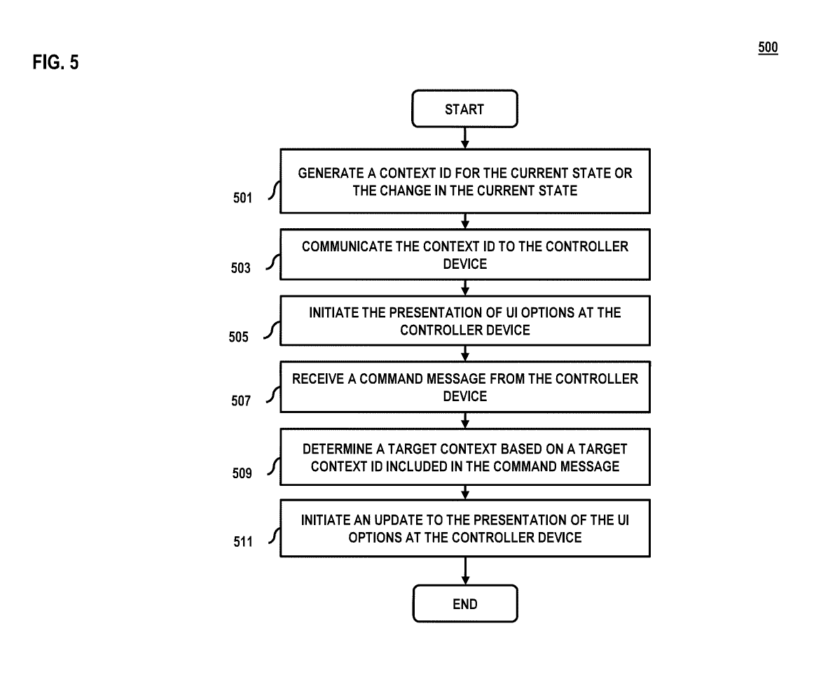

FIG. 5 is a flowchart of a process for generating and communicating status contextual information, according to one embodiment. For the purpose of illustration, process 500 is described with respect to FIG. 1. It is noted that the steps of the process 500 may be performed in any suitable order, as well as combined or separated in any suitable manner.

As shown in FIG. 5, in step 501, a RC application 107 may generate a context identifier for the current state or for the change in the current state. In one embodiment, an RC application 107 at a target device 101 may generate a context identifier based on a change in the current status in one or more applications associated with a content item. For example, an application 103 may be utilized to playback a media item from a list of content items available at the target device 101. In one use case scenario, if the state at the target device 101 changes to present a list of movie assets, then the context update message communicated to the controller device may contain a context identifier for the new state, the number of movies in the list, the position of a selected movie within the list, movie asset information such as title or asset identification, or the like. In one embodiment, a context identifier may represent the state of an application at a target device wherein a controller device may determine and present a UI based on that context identifier. In one embodiment, a controller device may include a context identifier in a control command message communicated to a target device so to identify the state of an application or a process targeted at the target device. In step 503, the RC application 107 may communicate the context identifier to the controller device via the context update message.

In step 505, the RC application 107 may initiate the presentation of the one or more user interface options at the controller device based on the context identifier. In one embodiment, an RC application 107 at a controller device 101 may process the context identifier and determine a UI and various options based on the context identifier. For example, a context identifier may indicate that a predefined UI should be presented at the controller device 101. In one example, an RC application 101 at the target device 101 may determine the UI and related options based on the context identifier and initiate a presentation of the UI and the options at the controller device 101.

In step 507, the RC application 107 may receive a command message from the controller device. In one scenario, a controller device 101 may generate a command message based on one or more user interactions with a UI and its options presented at the controller device 101 and communicate the command message to one or more target devices 101. For example, a command message may indicate a selection of a certain content item, application, or process at the target device 101 where the RC application 107 and/or application 103 may execute one or more actions at the target device 101.

In step 509, the RC application 107 may determine a target context based on a target context identifier included in the command message. In one scenario, the command message may include a target context identifier so that the RC application 107 at a target device 101 receiving the command message may determine an intended content item, application, process, or the like, which the user may wish to interact with and effectuate a state change. For example, to select and play a certain movie via a target set-top box. In one scenario, a target context identifier may be same as or may be based on a context identifier at a target device 101. In another scenario, an RC application 107 at a controller device 101 may include a list of target context identifiers, for example, the list may include one or more target context identifiers which may be based on one or more context identifiers at the target device 101 that are associated with one or more applications, processes, content items, and the like.

In step 511, the RC application 107 may initiate an update to the presentation of the one or more user interface options at the controller device based on the command message. In one embodiment, an RC application 107 at a target device 101 may determine an update to a UI and relevant options at a controller device 101 and/or at the target device 101. In one embodiment, the RC application 107 at a controller device 101 may update the UI and the options based on a command message sent to a target device 101. For example, after a controller device 101 sends a command to play an audio track at a target device 101, the UI and its options at the controller device 101 may include options to tune the audio dynamics at the target device 101.

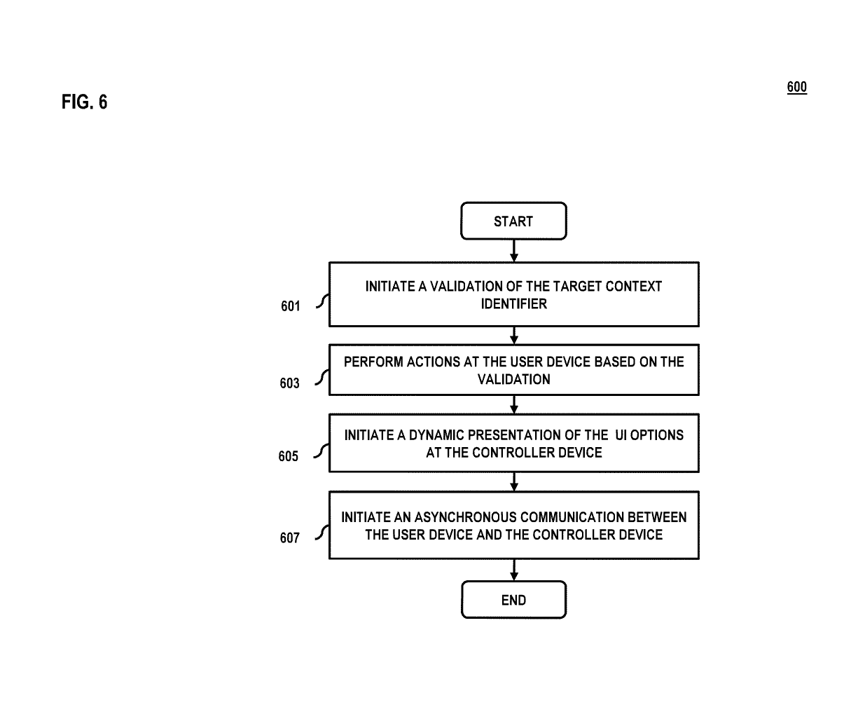

FIG. 6 is a flowchart of a process for validating and utilizing context identifiers, according to one embodiment. For the purpose of illustration, process 500 is described with respect to FIG. 1. It is noted that the steps of the process 500 may be performed in any suitable order, as well as combined or separated in any suitable manner.

As shown in FIG. 6, in step 601, a RC application 107 may initiate a validation of the target context identifier. In one embodiment, an RC application 107 at a target device 101 may determine validity of a target context identifier included in a command message. For instance, a context identifier received from a controller device 101 may be associated with one or more applications, processes, or content items active/available at the target device 101; however, it is possible that a target context identifier is no longer valid at the target device 101. For example, a content item identified by the target context identifier may no longer be available at the target device 101. In another example, an application/process identified by the target context identifier may be updated with a new context identifier at the target device 101. In case a target context identifier is not verified at a target device 101, then the target device 101 may notify the relevant controller device and/or take a default action at the target device 101.

In step 603, the RC application 107 may perform one or more actions at the user device based on the validation. In one embodiment, the context identifier may indicate to the target device 101 to perform a certain action on a certain process, application, or content item. For example, a context identifier may request for a content item to be archived into a personal library, or to resume playing of a media item, or to mark a media item as restricted to the user only, or to enquire about an update to a certain game or application, or the like.

In step 605, the RC application 107 may initiate a dynamic presentation of the one or more user interface options at the controller device based on one or more user preferences, one or more user profiles, content consumption history information, or a combination thereof. In one embodiment, the UI and related options at a controller device 101 may be dynamically updated and presented at the controller device 101 based on one or more state changes at a target device 101, one or more actions at the target device 101, one or more actions at the controller device 101, or the like. For example, a UI presentation may be based on one or more user preferences determined from the controller device 101, or from a user profile determined at the target device 101, or from content consumption history associated with the controller device 101 and/or the user information, or the like.

In step 607, the RC application 107 may initiate an asynchronous communication of the current state, the change in the current state or a combination thereof between the user device and the controller device. In various embodiments, an RC application 107 at a target device 101 or at a controller device 101 may initiate an asynchronous communication session with a target or a controller device 101 for communicating the current state or a change in the current state. For example, a target device 101 may initiate the asynchronous communication after a power-up, a reset, an update to list of available applications or content items, a loss of communication with a controller device 101, or the like. Similarly, a controller device 101 may initiate an asynchronous communication session based on user interactions, device status, UI options, or the like. For example, a controller device 101 may have lost communication with a target device 101 and the user is intending to communicate a command message to a target device 101.

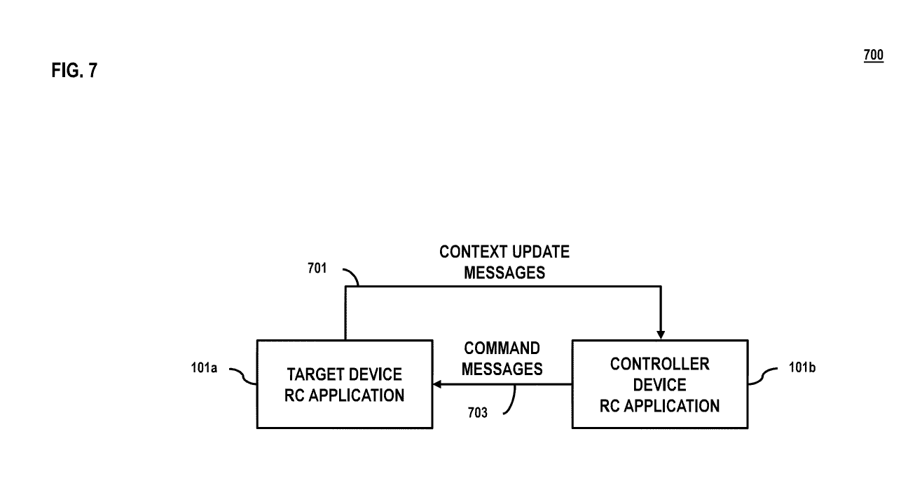

FIG. 7 is a diagram of a communication flow 700 between a target device and a controller device, according to one embodiment. In one embodiment, a target device 101a may utilize a communication channel 701 to transmit to a controller device 101b one or more context update messages. For example, the context update message may include various information items associated with a state of the target device 101a, e.g., relevant to one or more processes, applications, media items, device information, or the like. In various examples, the communication channel 701 may be via any wireless or wired communication channel available to the two devices. Further, the controller device 101b may utilize a communication channel 703 to communicate one or more command messages to the target device 101a for effectuating one or more state changes at the target device 101a. For example, the command message may include context identifiers associated with various applications, processes, media items, content items, or the like as well as action requests for interacting with the various applications, processes, media items, content items. In various embodiments, the communication channels 701 and 701 may be a same bi-directional channel or may be two different channels via a same or different protocol. For example, the 701 channel may be via a Bluetooth® channel and the 703 may be via a WLAN.

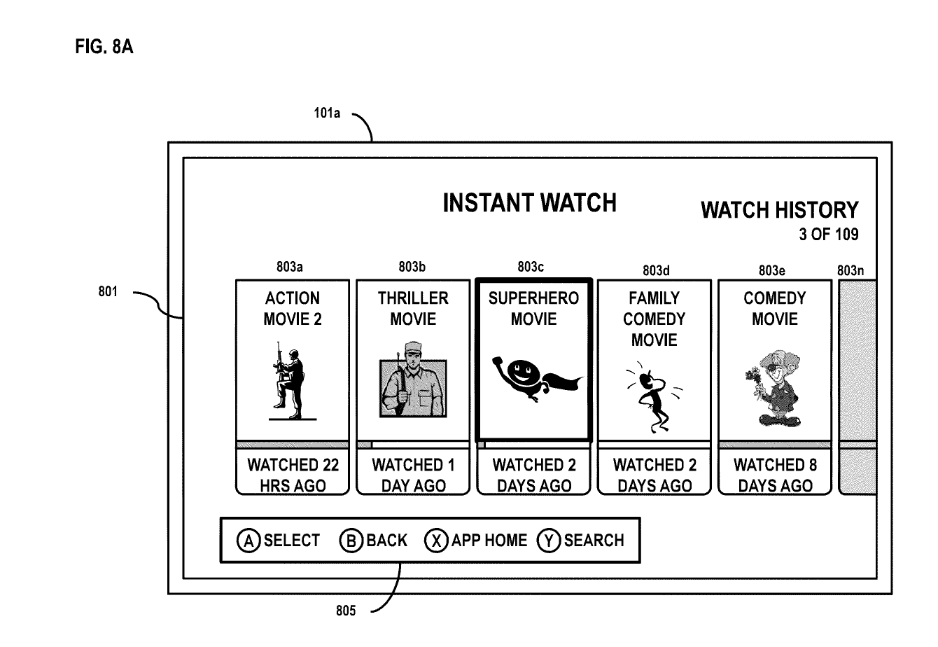

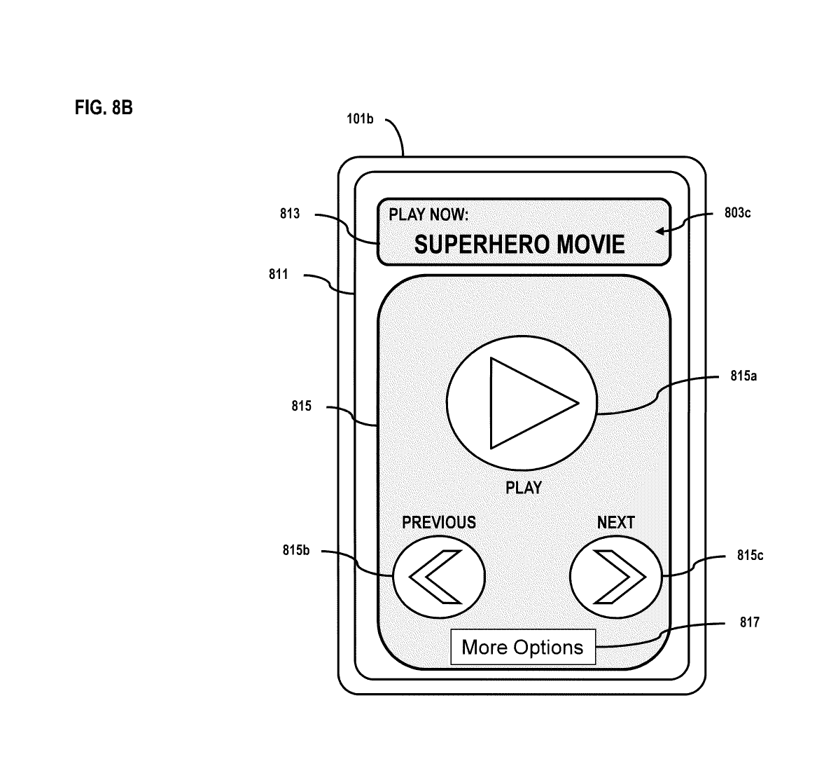

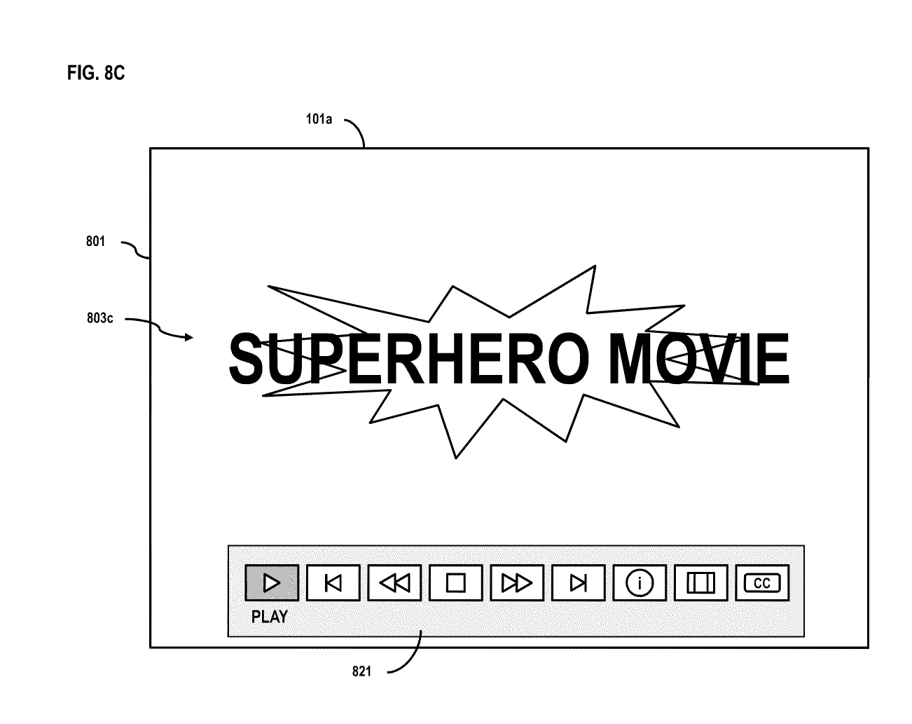

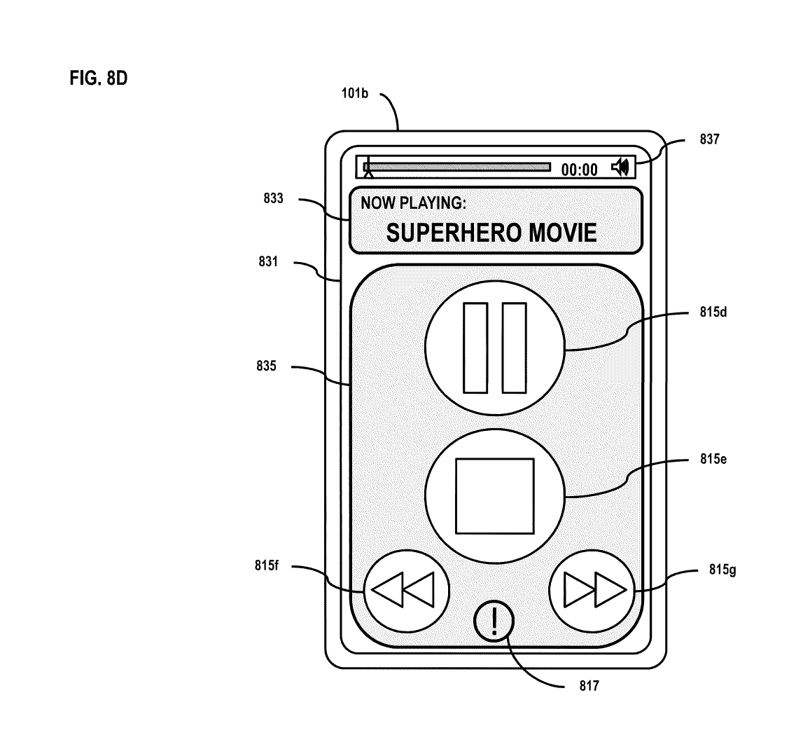

FIGS. 8A through 8D are diagrams of user interfaces for use in the processes of FIGS. 4 through 7, according to various embodiments.

FIG. 8A includes a user interface 801 at a target device 101a, which may be utilized to interact with a plurality of content items 803a-803n. In one example, the target device 101 may be a set-top box used to interface with a content or service provider for accessing and consuming various content items, which may be real-time content items or may be from one or more content libraries. In one scenario, one or more UI options 805 may be presented at a device associated with the target device 101a, for example, the set-top box may be connected to a TV set or that the functionality of the set-top box may be integrated with the TV set. Either way, the UI options 805 may be determined based on what is presented via the target device 101a. In the example in FIG. 8A, the content items 803a-803n present a list of watched/consumed movies, which may be associated with a user account, the target device 101a, or the like.

FIG. 8B includes a user interface 811 at a controller device 101b. In this example, the UI 811 includes information and user options based on the state of 101a of FIG. 8A where various content items 803a-803n were presented at the target device 101a. Additionally, the UI 811 includes an option 813 where the user may select to play the movie 803c presented in the 803 list. Further, the UI 811 may include various options 815 where the user may select from available options and interact with the content items in the 803 list, e.g., to play the movie at 815a, or to go to a previous movie at 815b, or to go to the next movie at 815c. In one embodiment, a command message from the controller device 101b may include a context identifier which the target device 101a may process to determine a target content item as well as an action requested by the user. For example, if a user selects the UI option 815a at the UI 811 at the controller device 101b, then the target device 101a may interpret that selection to option “A” in 805 applied to the movie 803c. In one embodiment, the UI 811 may include 817 where a user may select to request presentation of additional UI options. For example, additional options may be based on the options “X” and “Y” presented in the list of options 805.

FIG. 8C includes an updated user interface 801 at the target device 101a, which may be utilized to interact with a content item 803c at the target device 101a. In one embodiment, the UI 801 at the target device 101a may be updated to reflect an action based on a command message received from the controller device 101b. In one example, the UI 801 presents the selected movie item 803c and relevant UI options 821, which may be directly utilized to interact with the movie item 803c. For instance, the UI options 821 may options native to an application running on the target device 101a. However, a context update message to the controller device 101b may initiate the presentation of an updated UI 811 as UI 831 in FIG. 8D. In one embodiment, the UI 831 may have similar options as in 811 or may be dynamically updated to include options to reflect the state changes at the target device 101a. For example, the UI 831 includes indicator 833 “Now Playing: SUPERHERO MOVIE”, updated UI options 835, including options 815d-815g instead of the previous 815a-815c options, and 837 to indicate a progress bar, a timer, a volume level controller, and the like.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

The exemplary techniques and systems presented herein enables a context-aware remote controller application on one or more controller devices for interfacing with one or more target devices and controlling one or more functionalities and/or processes at the target devices. As an advantage, the device management application can enable a user device to interact with another user device to effectuate a remote control of processes, applications, content items, and the like at the other device. A remote control application may be utilized on the devices for determining and communicating various information, messages, and commands relevant to the remote control process. Additionally, the methods of the system 100 may provide for determination and presentation of a dynamic UI and relevant options at a target device and at a controller device based on the states at each device for a more efficient, user friendly, and relevant UI and options.

The processes described herein for facilitating a context-aware remote controller application may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

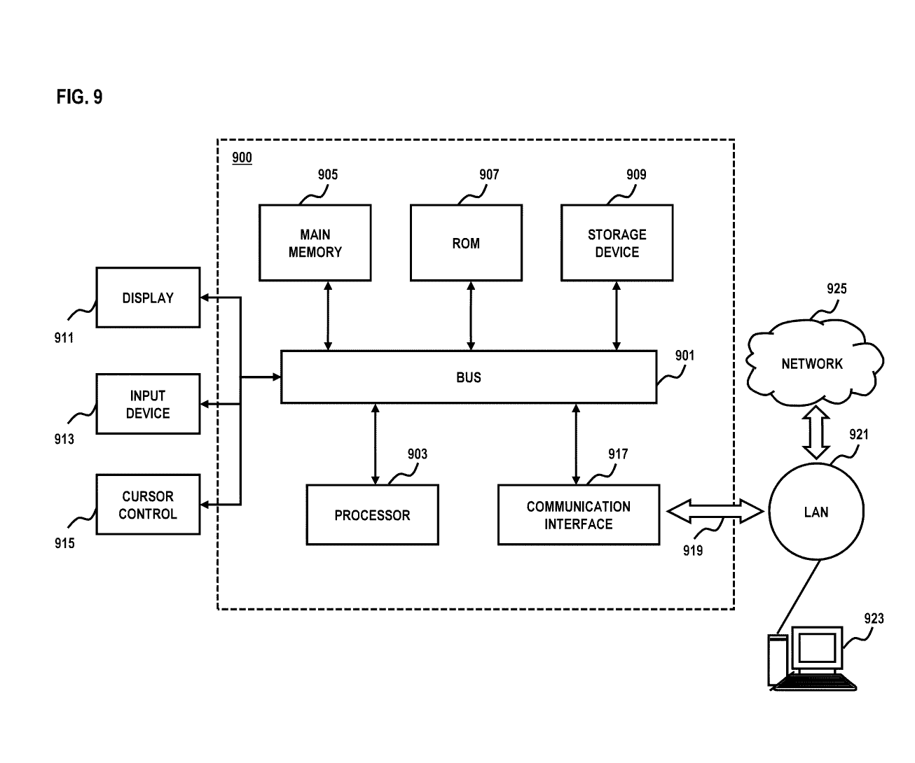

FIG. 9 illustrates computing hardware (e.g., computer system) upon which an embodiment according to the invention can be implemented. The computer system 900 includes a bus 901 or other communication mechanism for communicating information and a processor 903 coupled to the bus 901 for processing information. The computer system 900 also includes main memory 905, such as random access memory (RAM) or other dynamic storage device, coupled to the bus 901 for storing information and instructions to be executed by the processor 903. Main memory 905 also can be used for storing temporary variables or other intermediate information during execution of instructions by the processor 903. The computer system 900 may further include a read only memory (ROM) 907 or other static storage device coupled to the bus 901 for storing static information and instructions for the processor 903. A storage device 909, such as a magnetic disk or optical disk, is coupled to the bus 901 for persistently storing information and instructions.

The computer system 900 may be coupled via the bus 901 to a display 911, such as a cathode ray tube (CRT), liquid crystal display, active matrix display, or plasma display, for displaying information to a computer user. An input device 913, such as a keyboard including alphanumeric and other keys, is coupled to the bus 901 for communicating information and command selections to the processor 903. Another type of user input device is a cursor control 915, such as a mouse, a trackball, or cursor direction keys, for communicating direction information and command selections to the processor 903 and for controlling cursor movement on the display 911.

According to an embodiment of the invention, the processes described herein are performed by the computer system 900, in response to the processor 903 executing an arrangement of instructions contained in main memory 905. Such instructions can be read into main memory 905 from another computer-readable medium, such as the storage device 909. Execution of the arrangement of instructions contained in main memory 905 causes the processor 903 to perform the process steps described herein. One or more processors in a multiprocessing arrangement may also be employed to execute the instructions contained in main memory 905. In alternative embodiments, hard-wired circuitry may be used in place of or in combination with software instructions to implement the embodiment of the invention. Thus, embodiments of the invention are not limited to any specific combination of hardware circuitry and software.

The computer system 900 also includes a communication interface 917 coupled to bus 901. The communication interface 917 provides a two-way data communication coupling to a network link 919 connected to a local network 921. For example, the communication interface 917 may be a digital subscriber line (DSL) card or modem, an integrated services digital network (ISDN) card, a cable modem, a telephone modem, or any other communication interface to provide a data communication connection to a corresponding type of communication line. As another example, communication interface 917 may be a local area network (LAN) card (e.g. for Ethernet™ or an Asynchronous Transfer Mode (ATM) network) to provide a data communication connection to a compatible LAN. Wireless links can also be implemented. In any such implementation, communication interface 917 sends and receives electrical, electromagnetic, or optical signals that carry digital data streams representing various types of information. Further, the communication interface 917 can include peripheral interface devices, such as a Universal Serial Bus (USB) interface, a PCMCIA (Personal Computer Memory Card International Association) interface, etc. Although a single communication interface 917 is depicted in FIG. 9, multiple communication interfaces can also be employed.

The network link 919 typically provides data communication through one or more networks to other data devices. For example, the network link 919 may provide a connection through local network 921 to a host computer 923, which has connectivity to a network 925 (e.g. a wide area network (WAN) or the global packet data communication network now commonly referred to as the “Internet”) or to data equipment operated by a service provider. The local network 921 and the network 925 both use electrical, electromagnetic, or optical signals to convey information and instructions. The signals through the various networks and the signals on the network link 919 and through the communication interface 917, which communicate digital data with the computer system 900, are exemplary forms of carrier waves bearing the information and instructions.

The computer system 900 can send messages and receive data, including program code, through the network(s), the network link 919, and the communication interface 917. In the Internet example, a server (not shown) might transmit requested code belonging to an application program for implementing an embodiment of the invention through the network 925, the local network 921 and the communication interface 917. The processor 903 may execute the transmitted code while being received and/or store the code in the storage device 909, or other non-volatile storage for later execution. In this manner, the computer system 900 may obtain application code in the form of a carrier wave.

The term “computer-readable medium” as used herein refers to any medium that participates in providing instructions to the processor 903 for execution. Such a medium may take many forms, including but not limited to non-volatile media, volatile media, and transmission media. Non-volatile media include, for example, optical or magnetic disks, such as the storage device 909. Volatile media include dynamic memory, such as main memory 905. Transmission media include coaxial cables, copper wire and fiber optics, including the wires that comprise the bus 901. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

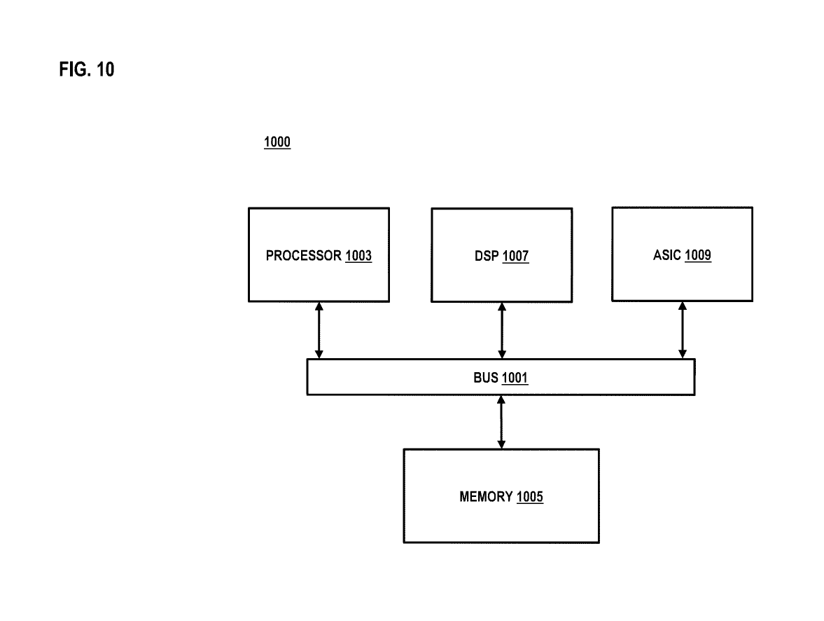

FIG. 10 illustrates a chip set 1000 upon which an embodiment of the invention may be implemented. Chip set 1000 is programmed to provide for implementing a context-aware remote controller application and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1000, or a portion thereof, constitutes a means for performing one or more steps of FIGS. 4-6.

In one embodiment, the chip set 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to controlling a set-top box based on device events. The memory 1005 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method of comprising:
determining a current state associated with one or more applications, one or more content items or a combination thereof at a user device;
communicating a change in the current state to a controller device via a context update message, wherein the context update message encodes the current state, the change in the current state, or a combination thereof as a context identifier; and
initiating a presentation of one or more user interface options at the controller device based on the context update message, the context identifier, or a combination thereof.

2. A method of claim 1, further comprising:
receiving a command message from the controller device;
determining a target context based on a target context identifier included in the command message; and
initiating an update to the presentation of the one or more user interface options at the controller device based on the command message.

3. A method of claim 2, further comprising:
initiating a validation of the target context identifier; and
performing one or more actions at the user device based on the validation.

4. A method of claim 1, wherein the one or more user interface options include one or more functionalities available at the user device, a list of content items available at the user device, a content consumption progress indicator, or a combination thereof.

5. A method of claim 1, wherein the presentation of the one or more user interface options at the controller device is further based on one or more activities at the controller device.

6. A method of claim 1, further comprising:
initiating a dynamic presentation of the one or more user interface options at the controller device based on one or more user preferences, one or more user profiles, content consumption history information, or a combination thereof.

7. A method of claim 1, further comprising:
initiating an asynchronous communication of the current state, the change in the current state or a combination thereof between the user device and the controller device.

8. A method of claim 1, wherein communication between the user device and the controller device is via a direct communication channel, via one or more network devices, or a combination thereof.

9. An apparatus comprising:
a processor; and
a memory including computer program code for one or more programs,
the memory and the computer program code configured to, with the processor, cause the apparatus to perform at least the following,
determine a current state associated with one or more applications, one or more content items or a combination thereof at a user device;
communicate a change in the current state to a controller device via a context update message, wherein the context update message encodes the current state, the change in the current state, or a combination thereof as a context identifier; and
initiate a presentation of one or more user interface options at the controller device based on the context update message, the context identifier, or a combination thereof.

10. An apparatus of claim 9, wherein the apparatus is further caused to:
receive a command message from the controller device;
determine a target context based on a target context identifier included in the command message; and
initiate an update to the presentation of the one or more user interface options at the controller device based on the command message.

11. An apparatus of claim 10, wherein the apparatus is further caused to:
initiate a validation of the target context identifier; and
perform one or more actions at the user device based on the validation.

12. An apparatus of claim 9, wherein the one or more user interface options include one or more functionalities available at the user device, a list of content items available at the user device, a content consumption progress indicator, or a combination thereof.

13. An apparatus of claim 9, wherein the presentation of the one or more user interface options at the controller device is further based on one or more activities at the controller device.

14. An apparatus of claim 9, wherein the apparatus is further caused to:
initiate a dynamic presentation of the one or more user interface options at the controller device based on one or more user preferences, one or more user profiles, content consumption history information, or a combination thereof.

15. An apparatus of claim 9, wherein the apparatus is further caused to:
initiate an asynchronous communication of the current state, the change in the current state or a combination thereof between the user device and the controller device.

16. An apparatus of claim 9, wherein communication between the user device and the controller device is via a direct communication channel, via one or more network devices, or a combination thereof.

17. A system comprising:
a remote control application configured to determine a current state associated with one or more applications, one or more content items or a combination thereof at a user device; communicate a change in the current state to a controller device via a context update message, wherein the context update message encodes the current state, the change in the current state, or a combination thereof as a context identifier; and initiate a presentation of one or more user interface options at the controller device based on the context update message, the context identifier, or a combination thereof.

18. A system of claim 17, wherein the remote control application is further configured to receive a command message from the controller device; determine a target context based on a target context identifier included in the command message; and initiate an update to the presentation of the one or more user interface options at the controller device based on the command message.

19. A system of claim 18, wherein the remote control application is further configured to initiate a validation of the target context identifier; and perform one or more actions at the user device based on the validation.

20. A system of claim 17, wherein the remote control application is further configured to initiate a dynamic presentation of the one or more user interface options at the controller device based on one or more user preferences, one or more user profiles, content consumption history information, or a combination thereof.
